(19) United States
(12) Patent Application Publication
(10) Pub. No.: US 2006/0005670 A1
(43) Pub. Date: Jan. 12, 2006

(54) Length adjustment device of lamp connection wire

(76) Inventor: Ki-Joo Kim, Gimhae-si (KR)

Correspondence Address: SCHMEISER OLSEN & WATTS, 18 E UNIVERSITY DRIVE, SUITE # 101, MESA, AZ, 85201, US

(21) Appl. No.: 11/176,511

(22) Filed: Jul. 6, 2005

(30) Foreign Application Priority Data
Jul. 6, 2004 (KR) 20-2004-0019124

(51) Int. Cl. B25B 7/00

(52) U.S. Cl. 81/300

(57) ABSTRACT

Disclosed herein is a length adjustment device of a lamp connection wire, which can easily and simply adjust the length of the lamp connection wire that connects a warming lamp to a power cutoff unit in a livestock barn. The length adjustment device has semicircular parts which are respectively provided on opposite ends of the length adjustment device, with a wire hole being formed through the center of each of the semicircular parts and allowing the lamp connection wire to pass through the wire hole. The semicircular parts are integrated into a single body by bridges, with a space defined between the bridges. In the length adjustment device, each of the bridges is integrally provided with a reinforcing ridge. Furthermore, each of the bridges is provided with at least one open circular hole at a position around the reinforcing ridge so that a power output cable, electrically connected to both the power cutoff unit and the warming lamp, can be tied to the length adjustment device. Because a farmer can easily and simply adjust the length of the lamp connection wire using the length adjustment device, the length adjustment device enhances work efficiency and saves labor while adjusting the heights of the lamps and prevents the power output cable from sagging or twisting.

### BACKGROUND OF THE INVENTION

1. Field of the Invention

The present invention relates generally to length adjustment devices of lamp connection wires and, more particularly, to a length adjustment device of a lamp connection wire, which can easily and simply adjust the length of the lamp connection wire that connects a warming lamp, installed in a livestock barn, to a power cutoff unit that has a mechanical structure to cut off power supply to the lamp when the lamp is unexpectedly broken by, for example, animals bred in the livestock barn, so that the length adjustment device increases work efficiency while adjusting the heights of the lamps in the livestock barn.

2. Description of the Related Art

Generally, livestock barns, such as pig barns, cowsheds or poultry houses, are equipped with a plurality of warming lamps to heat fresh young animals, for example, piglets, calves, or chickens, thus keeping the young animals warm and promoting the growth and development of the young animals.

In the related art, halogen lamps have been preferably used as the warming lamps to be installed in the livestock barns because the halogen lamps can provide multi-advantages in that the halogen lamps function as a lighting means to light the interior of the barns as well as a heat dissipating means to heat the air warm in the barns, and can reduce the consumed amount of electricity. However, the halogen lamps are expensive lamps, so that, in an effort to reduce the costs of the warming lamps, cheap incandescent lamps have been used as the warming lamps to be installed in livestock barns.

The halogen lamps and the incandescent lamps, which have been preferably used as warming lamps for livestock barns due to the above-mentioned advantages, are typically covered with protective shades thereon to efficiently reflect and radiate light from the lamps to young animals, thus promoting the growth and development of the young animals. The shades also protect the lamps from external shock. The halogen lamps and the incandescent lamps (herein below, the two types of lamps will be referred to simply as “warming lamps” without classification) are suspected to be closer to the animals as possible as in the winter season so as to maximize the warming efficiency of the lamps for the young animals. Described in detail, in the winter season, the warming lamps are suspended at substantially low heights of about 30-50 cm over the bottom of a livestock barn. Furthermore, because the young animals grow very quickly and curiously touch the warming lamps, the warming lamps have been configured such that the heights of the suspended lamps over the bottom of a livestock barn can be adjusted by an adjustment in the lengths of the lamp connection wires that connect the warming lamps to power cutoff units.

Because the warming lamps covered with the protective shades are typically suspended at low heights over the bottom in a livestock barn as described above, the curious young animals in the livestock barn may bite or peck at the lamps and shades and pull the lamps and shades with their mouths for fun. Thus, the animals sometimes break the lamps and shades. Furthermore, a fastening clamp, which secures the warming lamp to a desired place in the livestock barn, easily corrodes with rust due to superannuation so that the lamp may fall off the clamp and be broken. When the warming lamps are broken as described above, the power supply lines of the lamps may be broken to cause a short circuit and generate sparks, and leak electricity from the lines. Thus, a fire may be caused in the barn by the sparks, or the animals may be killed by the electric shock.

Furthermore, because curious young animals grow very quickly so that the young animals easily touch the lamps and shades as described above, farmers must repeatedly and frequently adjust the heights of the warming lamps over the bottom of the livestock barn and make the positions of the lamps higher and higher by repeatedly and frequently adjusting the lengths of the connection wires that connect the lamps to power cutoff units. However, the farmers may unconsciously forget to adjust the heights of the lamps over the bottom, or may consciously ignore the work of adjusting the heights of the lamps over the bottom of a livestock barn due to the troublesome work in which the farmers must manually adjust the heights of the lamps over the bottom by adjusting the lengths of the lamp connection wires one by one. When the adjustment of the heights of the lamps over the bottom is ignored, the livestock barns may be on fire or the animals bred in the barns may be killed by an electric shock.

Of course, in an effort to overcome the above-mentioned problems, the warming lamps may be suspended from the ceiling at higher positions where the animals cannot touch the lamps or shades. However, the warming lamps suspended at the higher positions are problematic in that the lamps cannot provide the same operational effects, such as warming effect capable of warming the animals, as that expected by the lamps placed at lower positions.

In an effort to solve the problems of the conventional warming lamps, the inventor of the present invention proposed a device in Korean U.M. Registration No. 0332380 (filed by the inventor under the title of “Power cutoff unit for warming lamps” and numbered as U. M. Application No. 2003-0024868). The power cutoff unit for warming lamps of 0332380 comprises a simple mechanical structure to cut off power supply to a warming lamp when the lamp is unexpectedly broken by animals in a livestock barn. The power cutoff unit can reduce the costs required to manufacture and install the warming lamps in a livestock barn. However, the power cutoff unit is problematic in that, when an animal pulls a warming lamp having the power cutoff unit so that both the housing of the power cutoff unit and the lamp fall down to the bottom of the livestock barn or when a clamp to secure the warming lamp to a desired place in the livestock barn has corroded with rust due to superannuation so that the lamp may fall off the clamp and be broken, the power cutoff unit cannot automatically cut off power supply to the lamp.

Thus, in order to overcome the above-mentioned problems of Korean U. M. Registration No. 0332380, the inventor of the present invention also proposed a plurality of embodiments of a power cutoff unit for warming lamps as disclosed in Korean Patent Application No. 200440272.

Described in detail, the power cutoff unit of 40272 is configured such that, when a fastening cable which supports the power cutoff unit to the ceiling of a livestock barn is loosened or broken so that both the power cutoff unit and a warming lamp connected to the power cutoff unit fall down to the bottom of the livestock barn, thus causing a breakage of the lamp, the power cutoff unit automatically cuts off power supply to the lamp. Thus, the power cutoff unit can prevent a fire from breaking out in the livestock barn and prevent animals from being killed by electric shock, so that the power cutoff unit of 40272 solves the problems caused in the power cutoff unit of 0332380.

Each of the power cutoff units proposed by the inventor of the present invention is advantageous in that, when a warming lamp is broken, the power cutoff unit can automatically cut off power supply to the lamp, thus preventing a fire from breaking out in the livestock barn and preventing animals from being killed by electric shock. However, each of the power cutoff units is problematic in that, because curious young animals grow very quickly so that the young animals can easily touch the lamps and shades, farmers must repeatedly and frequently adjust the heights of the warming lamps over the bottom of a livestock barn, thus making the positions of the lamps higher and higher by repeatedly and frequently adjusting the lengths of the connection wires that connect the lamps to power cutoff units. Thus, the farmers must frequently repeat the troublesome adjustment work, thus reducing work efficiency while breeding the animals in the barn. Furthermore, because many lamp connection wires must be repeatedly and frequently fastened and unfastened, the work efficiency while adjusting the heights of the lamps over the bottom becomes further reduced.

As described above, farmers must repeatedly and frequently adjust the heights of the warming lamps over the bottom of the livestock barn and make the positions of the lamps higher and higher according to the growing speed of young animals by repeatedly and frequently adjusting the lengths of the connection wires that connect the lamps to power cutoff units. However, when the farmers unconsciously forget to adjust the heights of the lamps over the bottom of a livestock barn, or consciously ignore the work of adjusting the heights of the lamps over the bottom due to the troublesome work in which the farmers must manually adjust the heights of the lamps over the bottom by adjusting the lengths of the lamp connection wires one by one. When the adjustment of the heights of the lamps over the bottom is ignored, the animals may pull the lamps (particularly, the protective shades of the lamps), so that the power cutoff unit cuts off the power supply to the lamps, thus stopping the warming function of the lamps. Therefore, the farmers must confirm electric statuses of the lamps one by one and manually connect power supply to the lamps, thus increasing the consumption of labor of the farmers and further reducing work efficiency while adjusting the heights of the lamps over the bottom of a livestock barn.

The above-mentioned problems will be described in more detail herein below with reference to FIG. 1.

FIG. 1 is a perspective view illustrating a structure which connects a warming lamp to a conventional power cutoff unit using a lamp connection wire. As shown in FIG. 1, a warming lamp 10, such as a halogen lamp or an incandescent lamp, is covered with a protective shade and is connected to a conventional power cutoff unit 30 by means of a lamp connection wire 20 so that the power cutoff unit 30 selectively cuts off power supply to the shaded lamp 10. The power cutoff unit 30 is supported to the ceiling of a livestock barn by a fastening means, such as a fastening cable 35. In the above state, the warming lamp 10 is electrically connected to the power cutoff unit 30 through a power output cable 32. In the drawing, the reference numeral 34 denotes a power input cable.

The structure to connect the warming lamp 10 to the power cutoff unit 30 comprises a locking ring 12 integrally formed on the center of the top surface of the lamp 10. To connect the warming lamp 10 to the power cutoff unit 30, the terminal end of the lamp connection wire 20 may be directly tied to the locking ring 12. Alternatively, the terminal end of the lamp connection wire 20 may pass through the locking ring 12 and be bound to the other part of the wire 20 by a fastening ring 22 as shown in FIG. 1, thus preventing the lamp 10 from undesirably dropping from the wire 20.

The warming lamp 10, connected to the power cutoff unit 30, is suspended from the power cutoff unit 30 such that the lamp 10 is placed close to the young animals on the bottom of the livestock barn by letting the lamp connection wire 20 down. Thus, the lamp 10 can more efficiently irradiate the young animals. Because curious young animals grow very quickly and may easily touch the shaded lamp 10, a farmer must repeatedly and frequently adjust the height of the lamp 10 over the bottom of the livestock barn and makes the position of the lamp 10 higher and higher by adjusting the length of the lamp connection wire 20. To raise the lamp 10 over the bottom of the barn according to the growth of the young animals, the fastening ring 22 which has bound the terminal end of the lamp connection wire 20 to the other part of the wire 20 is removed and, thereafter, the terminal end of the wire 20 is raised toward the power cutoff unit 30 so that the length of the wire 20 becomes reduced. After the length of the wire 20 is adjusted, the terminal end of the wire 20 is bound to the other end of the wire 20 by the fastening ring 22 so that the lamp 10 is fixed at the adjusted height over the bottom of the barn which does not allow the young animals to touch the lamp 10.

Thus, farmers must frequently, repeatedly and manually adjust the heights of the warming lamps over the bottom of a livestock barn by adjusting the lengths of the lamp connection wires one by one according to the quick growth of young animals, so that labor consumption is increased to reduce work efficiency while breeding the animals. Furthermore, because the fastening rings must be unfastened from the lamp connection wires and refastened to the wires one by one or the lamp connection wires must be untied from and retied to the locking rings during the repeated adjustment work, so that the amount of consumed time during the work is increased, thus reducing work efficiency while adjusting the heights of the lamps.

### SUMMARY OF THE INVENTION

Accordingly, the present invention has been made keeping in mind the above problems occurring in the prior art, and an object of the present invention is to provide a length adjustment device of a lamp connection wire, which can easily and simply adjust the length of the lamp connection wire that connects a warming lamp to a power cutoff unit, thus enhancing work efficiency while adjusting the length of the connection wire to adjust the height of the lamp over the bottom of a livestock barn.

Another object of the present invention is to provide a length adjustment device of a lamp connection wire, which is provided with at least one open circular hole to tie a power output cable, electrically connected to both the power cutoff unit and the warming lamp, to the length adjustment device, thus preventing the power output cable from sagging or twisting and preventing safety hazards from occurring or fire from braking out in the livestock barn due to damage to the power output cable.

In order to accomplish the above objects, the present invention provides a length adjustment device of a lamp connection wire to connect a warming lamp to a power cutoff unit the device comprising: semicircular parts respectively provided on opposite ends of the length adjustment device, with a wire hole being formed through the center of each of the semicircular parts and allowing the lamp connection wire to pass through the wire hole; and bridges which integrate the semicircular parts into a single body, with a space defined between the bridges.

In the length adjustment device, each of the bridges is integrally provided with a reinforcing ridge. Furthermore, each of the bridges is provided with at least one open circular hole at a position around the reinforcing ridge so that a power output cable, electrically connected to both a power cutoff unit and the warming lamp, can be tied to the length adjustment device.

Thus, the length adjustment devices according to the present invention can easily and simply adjust the length of the lamp connection wire, thus easily and simply adjusting the height of the warming lamp over the bottom of a livestock barn. Therefore, the present invention solves the problem of a conventional structure to connect the warming lamp to the power cutoff unit in which the connection wire must be repeatedly and frequently untied and retied. The present invention enhances work efficiency and saves labor while adjusting the heights of the warming lamps in the livestock barn. Furthermore, the present invention prevents the power output cable from sagging or twisting, thus preventing safety hazards from occurring or fire from braking out in the livestock barn due to damage to the power output cable.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating a conventional structure to connect a warming lamp to a power cutoff unit using a lamp connection wire;

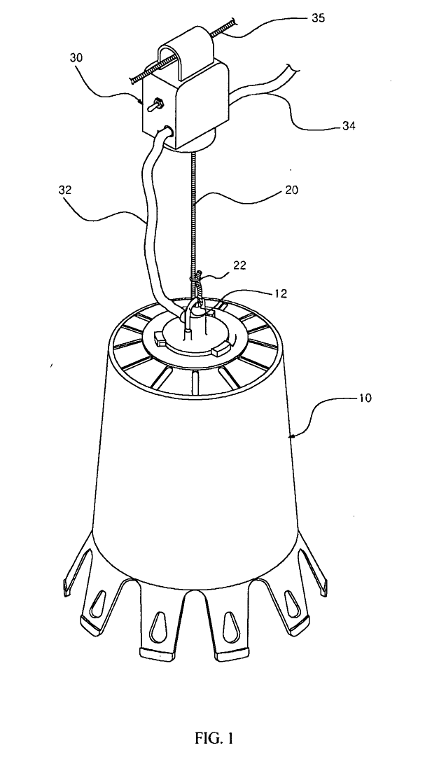

FIG. 2 is a perspective view illustrating a length adjustment device of a lamp connection wire according to the present invention;

FIG. 3 is an exploded perspective view illustrating the length adjustment device of the present invention which is used with a lamp connection wire;

FIG. 4 is a perspective view illustrating the length adjustment device of the present invention which is coupled to the lamp connection wire;

FIG. 5a is a perspective view illustrating operation of the length adjustment device of the present invention to increase the length of the lamp connection wire; and

FIG. 5b is a perspective view illustrating operation of the length adjustment device of the present invention to reduce the length of the lamp connection wire.

### DESCRIPTION OF THE PREFERRED EMBODIMENTS

Reference now should be made to the drawings, in which the same reference numerals are used throughout the different drawings to designate the same or similar components.

Herein below, a preferred embodiment of the present invention will be described in detail with reference to the accompanying drawings.

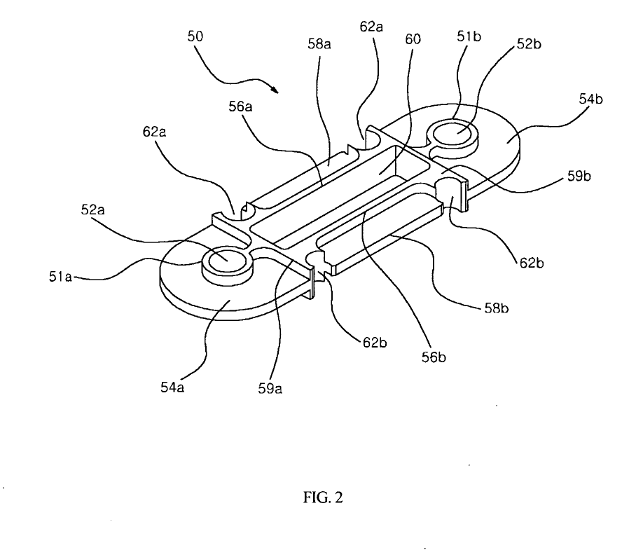

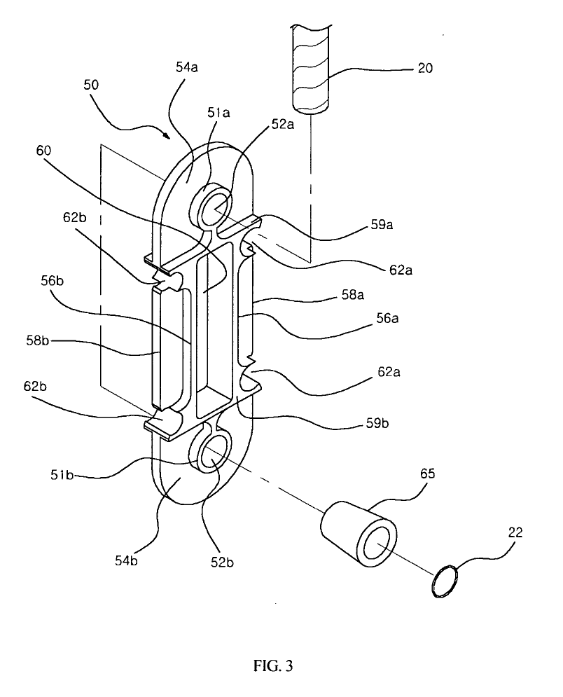

FIG. 2 is a perspective view illustrating a length adjustment device of a lamp connection wire according to the present invention. FIG. 3 is an exploded perspective view illustrating the length adjustment device of the present invention which is used with a lamp connection wire. As shown in the drawings, the length adjustment device of a lamp connection wire according to the present invention comprises an integrated body which has a symmetric structure and is produced through injection molding using a light material, such as plastic or Astal.

The length adjustment device 50 according to the present invention comprises two semicircular parts 54a and 54b which are respectively provided on opposite ends of the length adjustment device 50, with a wire hole 52a, 52b being formed through the center of each of the two semicircular parts 54a and 54b and allowing a lamp connection wire 20 to pass through the wire holes 52a and 52b. The lamp connection wire 20 connects a warming lamp 10 to a power cutoff unit 30. The length adjustment device further comprises two bridges 56a and 56b which are placed between the two semicircular parts 54a and 54b and integrate the semicircular parts 54a and 54b into a single body. Each of the bridges 56a and 56b is integrally provided with a reinforcing ridge 58a, 58b.

To increase the structural strength of the wire holes 52a and 52b of the length adjustment device 50 having the above-mentioned construction, a reinforcing circular boss 51a, 51b is formed around the edge of each of the wire holes 52a and 52b. The circular boss 51a, 51b has a height larger than the thickness of each of the semicircular parts 54a and 54b, thus reinforcing the strength of each of the wire holes 52a and 52b. Furthermore, the junction 59a, 59b between the bridges 56a and 56b and each of the semicircular parts 54a and 54b has a thickness equal to the thickness of each of the reinforcing circular bosses 51a and 51b of the wire holes 52a and 52b. The two bridges 56a and 56b are spaced apart from each other by a space 60 defined between the two bridges 56a and 56b so that the total weight of the length adjustment device 50 is reduced due to the spaced bridges 56a and 56b.

Each of the bridges 56a and 56b is provided with a plurality of open circular holes 62a and 62b at positions between opposite terminal ends of each of the reinforcing ridges 58a and 58b and the junctions 59a and 59b of the semicircular parts 54a and 54b and the bridges 56a and 56b. As shown in FIG. 3, a power output cable 32 of the power cutoff unit 30 can be tied to the device 10. The open circular holes 62a and 62b have different inner diameters so that the holes 62a and 62b can receive therein a variety of power output cables 32 having different outer diameters. Described in detail, because a variety of power output cables 32 having different outer diameters may be used with the length adjustment device 50, the open circular holes 62a and 62b have different inner diameters to stably receive therein the variety of power output cables 32.

The length adjustment device 50 having the above-mentioned construction according to the present invention will be used with a lamp connection wire as follows.

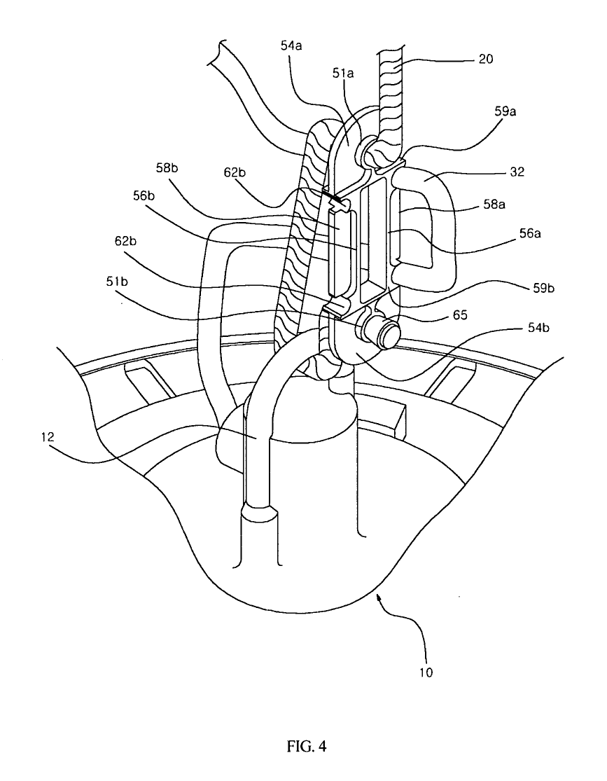

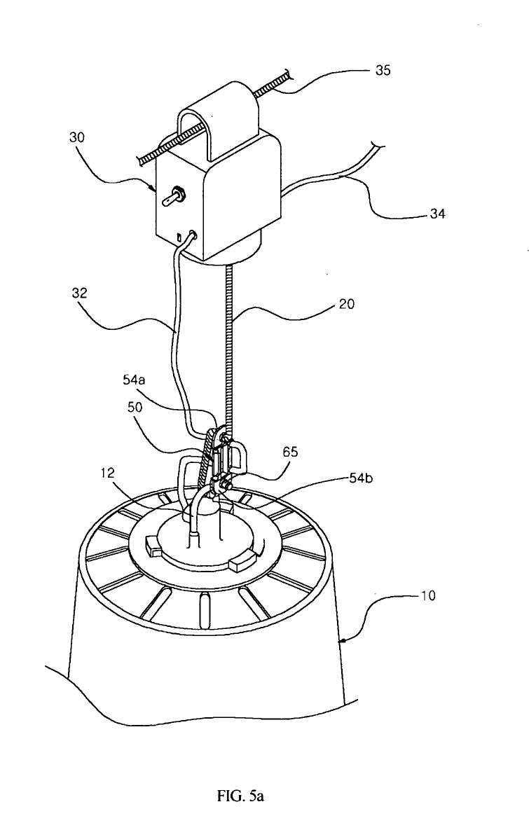

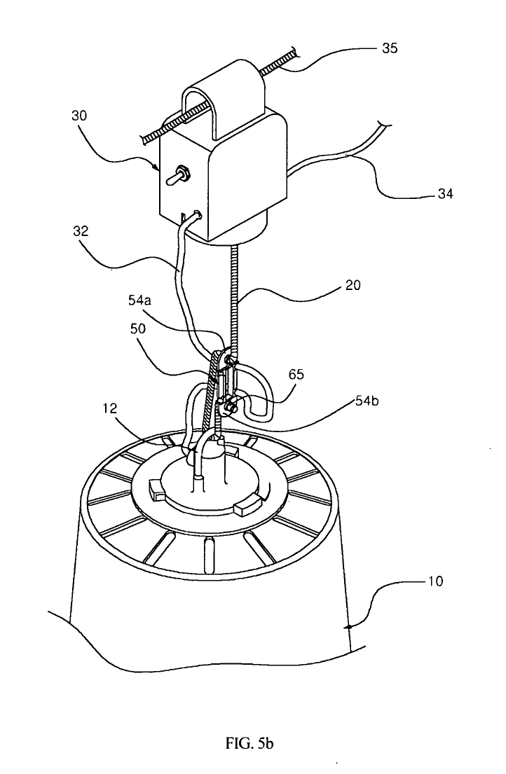

As shown in FIGS. 3 and 4, the warming lamp 10 is connected to the power cutoff unit 30 by means of a lamp connection wire 20. The power cutoff unit 30 is supported to the ceiling of a livestock barn by a fastening means, such as a fastening cable 35 as shown in FIGS. 5a and 5b. To couple the length adjustment device 50 to the connection wire 20, the terminal end of the connection wire 20 extending downwards from the power cutoff unit 30 passes through the first wire hole 52a formed through the first semicircular part 54a of the device 50 and, thereafter, passes through a locking ring 12 of the warming lamp 10. The terminal end of the connection wire 20 from the locking ring 12 of the warming lamp 10 passes through the second wire hole 52b formed through the second semicircular part 54a of the device 50. A fastening ring 22 fastens the terminal end of the connection wire 20, which extends outwards from the second wire hole 52b, to another part of the wire 20. Thus, the fastening ring 22 prevents the lamp connection wire 20 from being undesirably removed from the wire hole 52b and prevents the terminal end of the wire 20 from being loosened into strands. Furthermore, a protective cap 65 may cover the terminal end of the lamp connection wire 20 in an effort to provide a good appearance of the terminal end and cover the fastening ring 22.

In the above description, the fastening ring 22 is used to tie the terminal end of the lamp connection wire 20 to the other part of the wire 20 and prevent the wire 20 from being undesirably removed from the wire hole 52b. However, it should be understood that the terminal end of the wire 20 may be directly tied to the other part of the wire 20 without using the fastening ring 22. It is preferred to use the fastening ring 22 while considering the appearance of the fastening structure.

The power output cable 32, which is electrically connected to both the power cutoff unit 30 and the warming lamp 10, is fitted into the open circular hole 62a of the length adjustment device 50. Thus, the cable 32 is tied to the device 50 such that the cable 32 can be prevented from sagging or twisting.

The length adjustment device, which is coupled to the lamp connection wire as described above, will be operated as follows.

FIG. 5a is a perspective view illustrating operation of the length adjustment device of the present invention to increase the length of the lamp connection wire. FIG. 5b is a perspective view illustrating operation of the length adjustment device of the present invention to reduce the length of the lamp connection wire.

The warming lamp 10, which is connected to the power cutoff unit 30 by the locking ring 12 placed in a closed space between the lamp connection wire 20 and the length adjustment device 50 coupled to the wire 20, may be lowered towards the bottom of a livestock barn so that the lamp 10 is placed adjacent to animals in the barn. To lower the lamp 10 towards the bottom, the length adjustment device 50 of the present invention is placed close to the locking ring 12 of the lamp 10 as shown in FIG. 5a.

Furthermore, the warming lamp 10 may be raised upwards from the bottom of the livestock barn so that the lamp 10 is placed remote from the animals in the barn. To raise the lamp 10 upwards, the length adjustment device 50 of the present invention is moved upwards from the locking ring 12 of the lamp 10 as shown in FIG. 5b.

Described in detail, the lower end of the lamp connection wire 20 in FIG. 5a is pulled downwards toward the warming lamp 10 due to the weight of the lamp 10, while the upper end of the wire 20 is fixed to the power cutoff unit 30, thus being pulled upwards toward the cutoff unit 30. Thus, a tensile force acts on the lamp connection wire 20 and forces the wire 20 to be maintained in its vertically tensioned position. Therefore, the length adjustment device 50 coupled to the connection wire 20 is placed and maintained almost vertically. Described in more detail, the length adjustment device 50 intends to be placed vertically such that the first semicircular part 54a of the device 50 is oriented upwards, according to the tensile force which acts on the wire 20 and tensions the wire 20 vertically and force the wire 20 to be maintained in the vertical position.

To raise the lamp 10 in the above state to a desired height by reducing the length of the lamp connection wire 20 as shown in FIG. 5b, the position of the length adjustment device 50 is primarily changed from the vertical position to a horizontal position. Thereafter, the length adjustment device 50 is moved upwards along the connection wire 20 by a desired distance. In the above state, the lamp 10 is raised upwards along with the upward movement of the length adjustment device 50.

When the length adjustment device 50 has reached a desired position on the wire 20, the length adjustment device 50 which has been horizontally placed is released from the fingers of the farmer. Therefore, the device 50 is placed vertically, in which the first semicircular part 54a is oriented upwards due to the vertical tensile force that acts on the wire 20 due to the weight of the lamp 10.

In the above state, a tensile force acts on both the upper part and the lower part of the lamp connection wire 20 in opposite directions based on the first wire hole 52a (see FIG. 3) formed through the first semicircular part 54a of the length adjustment device 50. Furthermore, the second semicircular part 54b of the length adjustment device 50, to which the terminal end of the lamp connection wire 20 is fastened, is pulled toward the lamp 10 due to the weight of the lamp 10, thus being maintained in its vertical position. Due to the vertical position of the second semicircular part 54b, the first semicircular part 54a is maintained in its vertical position. In the above state, because the upper part and the lower part of the lamp connection wire 20 based on the first wire hole 52a of the first semicircular part 54a are made of a flexible material, the lamp connection wire 20 placed around the device 50 is bent to an S-shape by the interference between the wire 20 and the first wire hole 52a of the first semicircular part 54a. Thus, the lamp connection wire 20 is prevented from being undesirably unfastened from the device 50.

To lower the warming lamp 10 toward the bottom of the livestock barn until the lamp reaches a position adjacent to the animals in the livestock barn, the vertical position of the device 50 is changed to a horizontal position in the same manner as that described above. Thereafter, the length adjustment device 50 is lowered along the lamp connection wire 20 to a desired height.

In the above description of the present invention, the length adjustment device of the lamp connection wire has been described in that the device is used with the lamp connection wire 20 fixed to a power cutoff unit 30. However, it should be understood that the use of the length adjustment device is not limited to the above-mentioned use. In other words, the length adjustment device may be used with a lamp connection wire which is directly fixed to the ceiling or the wall of a livestock barn without using the power cutoff unit.

As described above, the present invention provides a length adjustment device of a lamp connection wire. The device can easily and simply adjust the length of the lamp connection wire that connects a warming lamp to a power cutoff unit. Thus, the length adjustment device does not make a farmer frequently untie and retie the lamp connection wires, thus enhancing work efficiency while adjusting the lengths of the lamp connection wires to adjust the heights of the lamps over the bottom of a livestock barn.

Furthermore, the length adjustment device of the lamp connection wire according to the present invention is provided with at least one open circular hole to tie a power output cable, electrically connected to both the power cutoff unit and the warming lamp, to the length adjustment device, thus preventing the power output cable from sagging or twisting and preventing safety hazards from occurring or fire from braking out in the livestock barn due to damage to the power output cable.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A length adjustment device of a lamp connection wire to connect a warming lamp to a power cutoff unit, the device comprising:
semicircular parts respectively provided on opposite ends of the length adjustment device, with a wire hole being formed through a center of each of the semicircular parts and allowing the lamp connection wire to pass through the wire hole; and
a bridge which integrates the semicircular parts into a single body.

2. The length adjustment device of the lamp connection wire according to claim 1, wherein the bridge is integrally provided with a reinforcing ridge.

3. The length adjustment device of the lamp connection wire according to claim 2, wherein the bridge is provided with at least one open circular hole at a position around the reinforcing ridge so that a power output cable, electrically connected to both the power cutoff unit and the warming lamp, is tied to the length adjustment device.

4. The length adjustment device of the lamp connection wire according to claim 3, wherein the open circular hole comprises two or more holes having different inner diameters.

5. The length adjustment device of the lamp connection wire according to claim 1, further comprising:
a reinforcing circular boss formed around an edge of the wire hole, the circular boss having a height larger than a thickness of each of the semicircular parts, thus reinforcing strength of the wire hole.

6. The length adjustment device of the lamp connection wire according to claim 2, further comprising:
a reinforcing circular boss formed around an edge of the wire hole, the circular boss having a height larger than a thickness of each of the semicircular parts, thus reinforcing strength of the wire hole.

7. The length adjustment device of the lamp connection wire according to claim 1, wherein a junction between the bridge and each of the semicircular parts has a thickness equal to the thickness of the reinforcing circular boss of the wire hole.

8. The length adjustment device of the lamp connection wire according to claim 2, wherein a junction between the bridge and each of the semicircular parts has a thickness equal to the thickness of the reinforcing circular boss of the wire hole.

9. The length adjustment device of the lamp connection wire according to claim 1, wherein the bridge comprises two bridges with a space defined between the two bridges.

10. The length adjustment device of the lamp connection wire according to claim 2, wherein the bridge comprises two bridges with a space defined between the two bridges.
